(19) United States
(12) Patent Application Publication
(10) Pub. No.: US 2005/0138049 A1
(43) Pub. Date: Jun. 23, 2005

(54) Method for personalized news

(75) Inventor: Greg Linden, Seattle, WA (US)

Correspondence Address: Greg Linden, 1415 E Valley St., Seattle, WA, 98112, US

(73) Assignee: Greg Linden, Seattle, WA (US)

(21) Appl. No.: 10/985,684

(22) Filed: Nov. 12, 2004

Related U.S. Application Data
(60) Provisional application No. 60/531,334, filed on Dec. 22, 2003.

(51) Int. Cl. G06F 17/00

(52) U.S. Cl. 707/100

(57) ABSTRACT

News sources, including news World Wide Web sites, provide a list of news articles on various topics to readers. Personalized news provides an individualized list of news articles depending on the specific interests of the readers. The invention describes a method of providing personalized news by computing related articles for each article, retaining a history of all articles read by a user, finding articles similar to articles previously read by a user, and merging those similar articles with a list of popular and recent news articles. When applied to a World Wide Web-based news application, the invention can be used to build a dynamic personalized news source that changes immediately and in real-time to reflect the interests of the readers.

### RELATED APPLICATIONS

This application claims the benefit of U.S. Provisional Application No. 60/531,334, filed Dec. 22, 2003.

### REFERENCES CITED

U.S. Patent Documents:

| | | | |
|---|---|---|---|
| 5,754,939 | May, 1998 | Herz et al. | 455/3.04 |
| 6,182,068 | March, 1999 | Culliss | 707/5 |
| 6,618,722 | July, 2000 | Johnson et al. | 707/5 |
| 6,539,377 | October, 2000 | Culliss | 707/5 |
| 6,256,633 | July, 2001 | Dharap | 707/10 |
| 6,460,036 | October, 2002 | Herz | 707/10 |

### OTHER REFERENCES

Chesnais et al “The Fishwrap Personalized News System”, IEEE 1995, pp. 275-282. E. J. Glover, S. Lawrence, M. D. Gordon, W. P. Birmingham, and C. L. Giles, “Recommending web documents based on user preferences,” ACM SIGIR 99 Workshop on Recommender Systems, Berkeley, Calif., August 1999. Glen Jeh and Jennifer Widom, “Scaling personalized web search,” Stanford University Technical Report, 2002.

### DESCRIPTION

1. Field of the Invention

The present invention relates to information retrieval and informational filtering for news databases. More specifically, the invention relates to methods for improving the apparent quality of a search query over a news database by changing the search results based on a user's interests and similarities between news articles.

### BACKGROUND OF THE INVENTION

News sources consist of a collection of news articles on various topics. News sources typically are organized manually by an editor who determines which articles are most important to the broad audience of users of the news source. On the World Wide Web, there are several news sites that provide news articles organized by an editor, by date, by importance, by popularity, by original source, or some combination of these methods. Some news site allow the user to customize way the news is displayed, specifying, for example, that news articles in specific topic areas (e.g. national news coverage) should be emphasized or deemphasized.

Personalized news shows a customized list of news articles to each user, a different organization and prioritization of the news articles for each user. Personalization is done primarily using implicit data about user interests gathered from user behavior. While there has been previous work on personalized news, these applications personalize by building a user profile to broadly define user interests. For example, a user who views a sports news article may have an interest in sports recorded in their profile, increasing the frequency of seeing sports articles. Our invention personalizes the news using fine-grained information about specific articles of interest to a specific user. With this method, the apparent quality of the news displayed is much higher since the articles are more closely aligned with user interests.

### SUMMARY OF THE DISCLOSURE

The present invention is a method for generating personalized news. An important benefit of the invention is that the reader is able to more easily and more quickly find news articles of interest. Another important benefit is that the site is customized to a reader's interests without the need for any explicit information from the user; articles previously viewed by the current user and by other users provide the information to personalize the news implicitly.

The news is personalized in two steps. First, collective user behavior and article data are analyzed to find relationships between articles. In this step, a related article data set is built that maps any given news article to a list of articles that are related or similar to the first article. Second, when an individual user reads the news, a record of all the articles the user has viewed in the past is retrieved, articles related to the previously viewed articles are found, and the related articles are merged into the default list of news articles to generate a unique and personalized list of news articles.

This brief description is merely a summary of the most important features of the invention so that the embodiments and claims described below can be better appreciated by those skilled in the art. There are additional features of the invention that will be described in the claims. This description should not be regarded as limiting the application of this invention.

### DETAILED DESCRIPTION OF PREFERRED EMBODIMENTS

The various features and methods of the invention will now be described in the context of a web-based news site. Those skilled in the art will recognize that the method is applicable to other types of documents. By way of example and not limitation, the invention could be used for a database that includes journal articles, weblog articles, product information, real estate listings, and many other time-sensitive documents. Those skilled in the art will recognize that the method is applicable to other display devices. By way of example and not limitation, the invention could display on mobile or handheld devices, cellular phones, applications on a computer desktop, and on computers and televisions using transmission protocols other than HTTP.

Throughout the description of the preferred embodiments, implementation-specific details will be given on how various data sources could be used to personalize the search results. These details are provided to illustrate the preferred embodiment of the invention and not to limit the scope of the invention. The scope of the invention will be set in the claims section.

To describe how personalized news may be implemented, it is important to understand how an Internet news source operates. An internet news source consists of a web-based front end on top of a database containing a list of news articles. When a user visits a news web site to see the news, the articles usually are displayed in a predetermined order, often by recency, popularity, or in an order manually determined by an editor.

Because most users will not examine more than the first few news articles on the page, the ordering of the news articles is important. The most relevant or most useful news articles should be placed near the top of the page. Many techniques have been used for ordering the news articles, including manual ordering, overall frequency that the news article is viewed, the ratings of the news article using various types of rating systems, importance of the news article using a manually provided rank of importance, by recency, or by a combination of these methods. Most of these techniques will show the same news articles to any user, regardless of what the user has done in the past.

To personalize the news articles, a record of the history the news articles viewed must be maintained for each user. In the preferred embodiment, the data is stored in a separate database called the history database. When the user clicks to view a news article, an identifier for that news article is stored in the history database. In the preferred embodiment, the database is an in-memory server-side database maintaining the historical data for a limited period of time. However, storing the data in file-based system, on the client, or for longer duration does not change the nature of the invention.

In addition to a record of articles viewed for each user, the invention requires a related articles database. The related articles database maps any given article to a list of related or similar articles. While many definitions of related or similar articles are possible without changing the nature of the invention, the preferred embodiment uses a combination of correlations in collective user behavior and matches between keyword, category, and source information between articles to determine similarity.

Specifically, in the preferred embodiment, the related articles database is built by individually computing similarity from correlations in collective user behavior, keywords in common, categories in common, and source information in common. The similarity scores from each of these computations are combined in a weighted sum. The final step biases the similarity to favor more recently published news articles. The specific algorithms are as follows:

Similarity from correlations in collective user behavior:

For each article, a₁

For each user u₁ who viewed article a₁

For each article a₂ viewed by user u₁

Add 1/sqrt(Num(a₁) * Num(a₂)) to similarity
score where Num(a₁) is the number of users who
viewed a₁ and Num(a₂) is the number of users who
viewed a₂.

Similarity from keywords:

For each article, a₁

For each keyword k₁ of article a₁

For each article a₂ containing keyword k₁

Add wₖ/p(k₁) to similarity score where p(k₁) is
the probability of an article containing
keyword k₁ (the frequency of the keyword) and Wₖ
is an arbitrary weight for the importance of
keyword similarities in the overall similarity
score.

Similarity from categories:

For each article, a₁

For each categories c₁ of article a₁

For each article a₂ containing category c₁

Add w_{c}/p(c₁) to similarity score where p(c₁) is
the probability of an article containing
category c₁ (the frequency of the category) and
w_{c} is an arbitrary weight for the importance of
category similarities in the overall similarity
score.

Similarity from sources:

For each article, a₁

For each article a₂ from the same source s₁ as article a₁

Add Wₛ/p(s₁) to similarity score where p(s₁) is the
probability of an article coming from source s₁ (the
frequency of the source) and wₛ is an arbitrary weight
for the importance of source similarities in the
overall similarity score.

In the preferred embodiment, the weights wₖ, w_{c}, and wₛ were determined arbitrarily after analyzing the similarity data. These weights are likely to change over time. Varying these weights or using a different method of combining the similarity scores does not change the nature of the invention.

In the preferred embodiment, limits are placed on the maximum amount any individual user correlation or keyword, category, or source match can contribute to the overall similarity. With this method, the influence of sparse data (very infrequently seen keywords or articles with only a few ratings) is limited. Other methods of handling sparse data could be used without changing the nature of the invention.

In the preferred embodiment, only articles viewed are used when analyzing correlations in collective user behavior. However, it would be trivial to add a mechanism to allow users to explicitly rate articles. Using ratings data does not change the nature of the invention.

In the preferred embodiment, no user profile is built. For example, the personalized news source could be extended to track broad category, keyword, and source interests of users and bias the news source using this profile. Adding this feature is trivial and does not change the nature of the invention.

In the preferred embodiment, similarity scores from four sources—user viewing behavior, keyword matches, category matches, and source matches—are combined. Using a subset of these sources or adding additional sources to this set does not substantially change the nature of the invention.

Having built a related articles database, we can now generate personalized news. The preferred embodiment determines all the previously viewed news articles, finds the top N articles related to each article, merges the related articles in with the default ordering of the news articles, and displays the result. The algorithm starts by finding a default list of the top N articles (where N is 100 in the preferred embodiment):

For each article a₁

Score = recency + wₚ * popularity where recency is how many
hours old the article is, popularity is the number of users
who viewed the article, and wₚ is an arbitrary weight.

Sort articles by score, pick the top N.

In the preferred embodiment, wₚ was arbitrarily determined after analyzing the data and recency treated all articles older than 36 hours as the same. Changing these parameters or using a different method of combining recency and popularity does not change the nature of the invention.

Then, articles related to articles viewed by the user are found and merged into the default list to determine the final list of news articles.

Start with the top N articles, the candidate list
For each article a1 the user has viewed

For each article a₂ related to a₁

Add a₂ into the list of candidate articles

In the preferred embodiment, the top 5 related articles are inserted into the candidate list by scattering them across the top positions (e.g. insert into the 1^{st}, 4^{th}, 7^{th}, 10^{th}, and 13^{th} positions). This provides one method of avoiding showing too many articles on the same topic to a user. Using another method of merging the related articles into the candidate list does not change the nature of the invention.

### SUMMARY

The invention provides a method of building a personalized news source that displays different news articles to different users depending on user interests. The method works using implicit data, tracking articles each user has viewed and favoring articles related to previously viewed articles. The related articles database is built from a combination of the correlations between articles in overall user viewing behavior and keyword, category, and source matches. A personalized news source built using this method can dynamically adapt to the interests of a user, immediately showing the most relevant articles to a user's interests. A reader viewing a news source built with this method will be able to more quickly and easily find interesting news articles.

1. In a multi-user computer system that provides user access to a database of news articles, a method of providing personalized news from the database, the method comprising the computer-implemented steps of:
(a) generating a data structure which maps individual news articles in a database to a corresponding set of similar news articles;
(b) for each article a user has viewed in the past, accessing the data structure defined in step (a) to identify a corresponding set of similar news articles;
(c) modifying the news articles shown to a user based at least in part on the similar news articles generated in step (b);
wherein step (a) is performed in an off-line mode, and steps (b) and (c) are performed substantially in real time in response to a request by the user.

2. The method of claim 1, wherein step (a) comprises analyzing news articles viewed by users of the system to identify correlations between the news articles.

3. The method of claim 1, wherein step (a) comprises analyzing the content of news articles such as the keywords, sources, or categories of news articles to identify correlations between the articles.

4. In a multi-user computer system that provides user access to a database of documents, a method of providing a personalized list of documents from the database, the method comprising the computer-implemented steps of:
(a) generating a data structure which maps items in a database to a corresponding set of similar documents where similarity is based at least in part on correlations between documents viewed by users or correlations between the content of the documents;
(b) for each of a set of documents previously viewed by a user, accessing the data structure defined in step (a) to identify a corresponding set of similar documents;
(c) showing a user a list of documents based at least in part on the similar documents generated in step(b);

5. A method of modifying the results from a search of a database of news articles comprised the computer-implemented steps of:
(a) accessing the database using a search query;
(b) accessing a database containing a history of news articles previously viewed by the user;
(c) for each of the items in step (b), accessing a database containing similar news articles;
(d) modifying the list from step (a) using the articles from steps (b) and (c).

6. The method of claim 5, wherein the database of similar articles in step (c) is built at least in part by comparing the number of users who viewed two news articles at least once with the number of users who viewed each news articles individually.

7. The method of claim 5, wherein the database of similar articles in step (c) is built at least in part by determining the number of keywords, categories, authors, or sources that a pair of news articles has in common.

8. The method of claim 5, wherein step (d) uses the data from step (b) to penalize or eliminate any article that the user has already viewed in the list from step (a).

9. The method of claim 5, wherein step (d) adds at least some of the similar news articles from step (c) to the original set from step (a).

10. A method of searching a database of news articles where news articles similar to those previously viewed are added to or favored in the search results.

11. The method of claim 10, wherein news articles similar to those previously viewed are determined at least in part by finding articles that have the same keywords, categories, sources, or authors as the articles previously viewed.

12. The method of claim 10, wherein news articles similar to those previously viewed are determined by at least in part by the number of users that viewed both articles relative to a number of users that viewed one or the other article.
